(19) United States
(12) Patent Application Publication
(10) Pub. No.: US 2006/0176707 A1
(43) Pub. Date: Aug. 10, 2006

(54) Holder for a string of lights

(76) Inventor: Richard Taylor Holt, Colorado Springs, CO (US)

Correspondence Address: LAW OFFICE OF DALE B. HALLING, LLC, 655 SOUTHPOINTE COURT, SUITE 100, COLORADO SPRINGS, CO, 80906, US

(21) Appl. No.: 11/352,490

(22) Filed: Feb. 10, 2006

Related U.S. Application Data
(60) Provisional application No. 60/651,673, filed on Feb. 10, 2005.

(51) Int. Cl. F21V 27/00; F21V 21/00

(52) U.S. Cl. 362/387; 362/249

(57) ABSTRACT

A holder for a string of lights includes a number of rods grouped into pairs, wherein each pair of rods are essentially collinear. Every pair of rods is orthogonal to every other pair of rods. Each of the rods have an outer tip that are essentially points on a sphere. A hollow sphere is removably attached to the rods. The hollow sphere is formed of two parts.

### RELATED APPLICATIONS

The present invention claims priority on provisional patent application, Serial No. 60/651,673, filed on Feb. 10, 2005, entitled “Holder for a String of Lights” and is hereby incorporated by reference.

### FIELD OF THE INVENTION

The present invention relates generally to the field of containers and more particularly to a holder for a string of lights.

### BACKGROUND OF THE INVENTION

Every year people take out strings of Christmas lights that were used last year. The string of lights originally come in a nice box that often holds the lights in an accordion type layout. Once the string of lights are removed from the brackets in the accordion type layout it is almost impossible to put the string of lights back in the original packaging. As a result, the string of lights tend to get tangled up no matter how the user attempts to store them. The most common solution today are reel type devices on the market, where the string of lights are wound around a reel. Although these devices prevent the string of lights from becoming tangled, they are difficult to use when an individual is trying to put on or take off the string of lights from a tree.

Thus, there exists a need for a holder for a string of lights that prevents the string of lights from becoming tangled and is easy to use when an individual is trying to put on or take off the string of lights from a tree.

### SUMMARY OF INVENTION

A holder for a string of lights that over comes these and other problems has a number of rods. A bracket is attached to the rods and holds the rods at equal angular spacing over a sphere. The bracket may be a hollow sphere. the rods may be removable from the hollow sphere. The rods may be essentially orthogonal to each other. The rods may consist of three pair of rods. Each of the pair of rods may be essentially collinear.

In one embodiment, a holder for a string of lights includes a number of dowels. A central bracket is affixed to the dowels. The dowels may consist of three pair of dowels. Each pair of dowels may be essentially collinear. The three pair of dowels may be essentially orthogonal to each other. The central bracket may be a sphere. The sphere may be formed of two parts. The sphere may be hollow. The dowels may be removable from the sphere.

In one embodiment, a holder for a string of lights includes a number of rods grouped into pairs, wherein each pair of rods are essentially collinear. Every pair of rods is orthogonal to every other pair of rods. Each of the rods have an outer tip that are essentially points on a sphere. A hollow sphere is removably attached to the rods. The hollow sphere is formed of two parts.

### BRIEF DESCRIPTION OF THE DRAWINGS

FIG. 1 is a perspective view of a holder for a string of lights in accordance with one embodiment of the invention;

FIG. 2 is a perspective view of a holder for a string of lights holding a string of lights in accordance with one embodiment of the invention;

FIG. 3 is a cross sectional view of a holder for a string of lights in accordance with one embodiment of the invention; and

FIG. 4 is a cross section view of a central bracket in accordance with one embodiment of the invention.

### DETAILED DESCRIPTION OF THE DRAWINGS

The present invention is a holder for a string of lights that prevents the string of lights from becoming tangled and is easy to use when an individual is trying to put on or take off the string of lights from a tree. The holder has a central bracket that holds a number of rods that extend out at roughly equal angles. The three dimensional reel shape keeps the lights from becoming tangled and makes it easy to use when an individual is trying to put on or take off the string of lights from a tree. This is because the holder is able to rotate in any direction the user needs the holder to move.

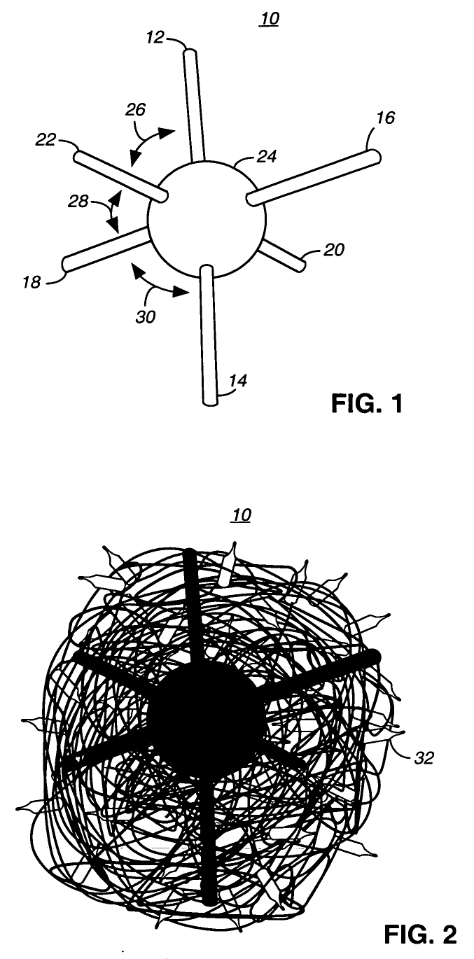

FIG. 1 is a perspective view of a holder 10 for a string of lights in accordance with one embodiment of the invention. The holder 10 has a number of rods 12, 14, 16, 18, 20 & 22. The rods are held by a central bracket 24 that is a sphere in this case. The rods 12, 14, 16, 18, 20 & 22 are in pairs 12-14, 16-18 & 20-22. Each pair of rods 12-14, 16-18 & 20-22 are essentially collinear. While the angular spacing 26, 28, 30 between the pair of rods 12-14, 16-18 & 20-22 is essentially orthogonal. FIG. 2 is a perspective view of a holder 10 for a string of lights holding a string of lights 32 in accordance with one embodiment of the invention.

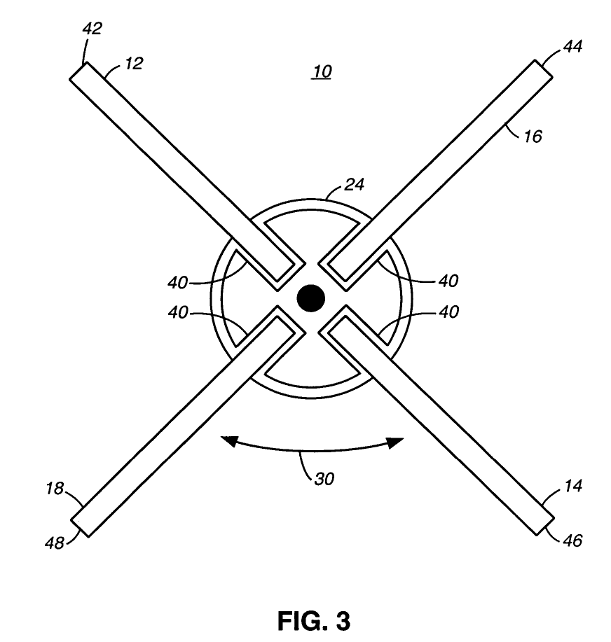

FIG. 3 is a cross sectional view of a holder 10 for a string of lights in accordance with one embodiment of the invention. The holder 10 has a bracket 24 that is a hollow sphere. The holder 10 has slots 40 that engage the rods 12, 14, 16, & 18. The rods are removably attached to the bracket 24 by the slots 40. This makes it easy to store the holder 10 or for shipping. Note that the pair of rods 12 & 14 (16 & 18) are essentially collinear. In addition, note that the tips 42, 44, 46, 48 of the rods 12, 14, 16, & 18 or dowels are essentially the points on sphere (circle in cross section). The dowels 12, 14, 16, & 18 and the central bracket 24 may be made of plastic, wood or any material that is strong and light enough for the function described herein.

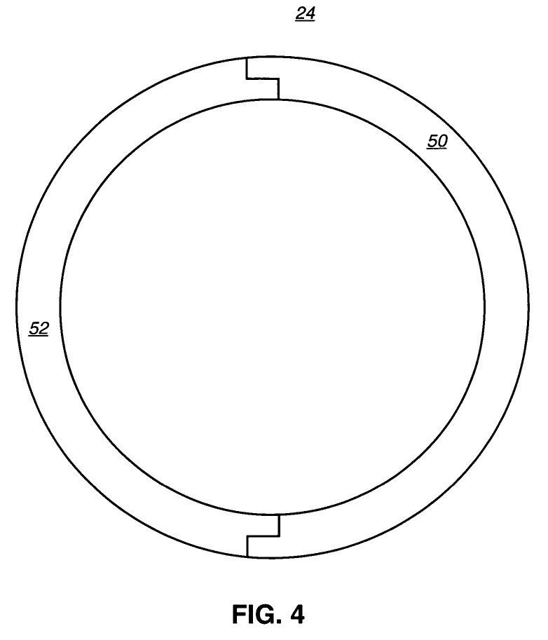

FIG. 4 is a cross section view of a central bracket 24 in accordance with one embodiment of the invention. The central bracket 24 in this embodiment is a hollow sphere. The sphere is formed of two parts 50, 52 that snap together.

Thus there has been described a holder for a string of lights that prevents the string of lights from becoming tangled and is easy to use when an individual is trying to put on or take off the string of lights from a tree.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A holder for a string of lights, comprising:
a plurality of rods; and
a bracket attached to the plurality of rods and holding the rods at equal angular spacing over a sphere.

2. The holder of claim 1, wherein the bracket is a hollow sphere.

3. The holder of claim 2, wherein the plurality of rods are removable from the hollow sphere.

4. The holder of claim 1, wherein the plurality of rods are essentially orthogonal to each other.

5. The holder of claim 4, wherein the plurality of rods consist of three pair of rods.

6. The holder of claim 5, wherein each pair of rods are essentially collinear.

7. A holder for a string of lights, comprising:
a plurality of dowels; and
a central bracket affixed to the plurality of dowels.

8. The holder of claim 7, wherein the plurality of dowels consist of three pair of dowels.

9. The holder of claim 8, wherein each pair of dowels are essentially collinear.

10. The holder of claim 9, wherein the three pair of dowels are essentially orthogonal to each other.

11. The holder of claim 7, wherein the central bracket is a sphere.

12. The holder of claim 11, wherein the sphere is formed of two parts.

13. The holder of claim 12, wherein the sphere is hollow.

14. The holder of claim 13, wherein the plurality of dowels are removable from the sphere.

15. A holder for a string of lights comprising:
a plurality of rods grouped into pairs, wherein each pair of rods are essentially collinear, and every pair of rods is orthogonal to every other pair of rods, each of the plurality of rods having an outer tip that are essentially points on a sphere; and
a hollow sphere removably attached to the plurality of rods, the hollow sphere formed of two parts.
